(19) United States
(12) Patent Application Publication
(10) Pub. No.: US 2026/0235417 A1
(43) Pub. Date: Aug. 13, 2026

(54) METHOD AND SYSTEM FOR DETERMINING A ZONE FOR AN AREA ON A MAP

(71) Applicant: GRABTAXI HOLDINGS PTE. LTD., Singapore (SG)

(72) Inventors: Panos MAVROKONSTANTIS, Singapore (SG); Wanyu ZHENG, Singapore (SG); Chunda DING, Beijing (CN); Xin XU, Singapore (SG)

(73) Assignee: GRABTAXI HOLDINGS PTE. LTD., Singapore, SG (SG)

(21) Appl. No.: 19/470,745

(22) PCT Filed: Mar. 27, 2024
(86) PCT No.: PCT/SG2024/050183

§ 371 Date: Sep. 29, 2025

(30) Foreign Application Priority Data
Mar. 31, 2023 (WO) PCT/CN2023/085406

(51) Int. Cl. G01C 21/00; G06Q 10/083

(52) U.S. Cl. CPC G01C 21/3874; G06Q 10/08355

(57) ABSTRACT

The present disclosure provides methods and systems for determining a zone for an area on a map. In some examples, there is provided a method comprising: determining, by a processor, for an area on a map, one or more other areas on the map based on a plurality of trips between the area nd each of the one or more areas, each of the area and the one or more other areas corresponding to at least one of a start location and an end location of at least one of the plurality of trips; and determing, by the processor, for the area, a corresponding zone based on a corresponding proportion fo the plurality of trips between the area and each of the one or more other areas, the zone indicating an association of the area with at least one of the one or more other areas.

### FIELD OF INVENTION

The present disclosure relates broadly, but not exclusively, to methods and systems for determining a zone for an area on a map.

### BACKGROUND

Driver shift is an alternative mode for drivers to provide ride and delivery services with ride-hailing and/or delivery platforms. Unlike the traditional mode in which drivers receive city-wide jobs, by participating in driver shifts, drivers need to select a particular predefined time-area slot and they will only receive jobs picking up and dropping off within the predefined area (e.g., a shift zone). It typically operates on a fully opt-in basis as drivers have full control over their signing up decisions. As incentives, shift drivers can enjoy exclusive benefits if minimum requirements are fulfilled, such as maintaining requirements for minimum online hours, acceptance rates, etc. during their shift. The benefits may include but not limited to allocation priority, earning stability, higher efficiency, etc.

Driver shift is expected to be effective as it is supposed to target drivers with geo-temporally similar concentrated trips. Pickup and drop off locations are near each other within a geographical boundary, such that demand density for ride and delivery services is high in the zones and drivers have higher chances to receive jobs, thereby increasing their utilization by reducing idle time. Trip distances are relatively shorter than the platform average since trips are constrained within the zone, so shift drivers are expected to complete more trips within the same duration compared to other non-shift drivers. Additionally, there would be a higher chance for a driver to receive a booking whose pick up location is close to its last drop off location, thereby reducing pickup time. As such, driver efficiency is expected to be higher as a result of shorter idle time, shorter pick up time and shorter trip completion time. If a non-linear pricing strategy is implemented such that shorter trips have higher price per kilometer (km), the accumulated earnings for shift trips should be higher compared to arbitrary trips covering the same total distance. In the long run, shift drivers are expected to build up familiarity with the particular area and further boost traveling efficiency.

However, there is no definitive and scalable method of creating optimal shift zones that best capture market demand patterns and are easy for drivers to navigate. One method is to manually define shift zone boundaries by joining district zones and identifying potentially effective zones, but it is not scalable and may not align with demand patterns, e.g., does not capture most intra-zone bookings, which is a key characteristic of shifts. This means that there is a ceiling to how much of the platform's demand can be fulfilled by shift drivers. Some platforms providing delivery services have similar zonal products in which certain disadvantages can be identified. For example, in some zonal products, the zones were drawn manually by incorporating the local context, due to the fact that boundary shapes of certain areas on a map are irregular and the boundaries are not always aligned with the road network. Manual zone drawing is slow, not scalable, difficult to update and may not optimally capture the market demand patterns. Not aligning the zone borders with the road network can also reduce drivers' navigation efficiency. Further, in some zonal products, the zones are granular and non-overlapping, which reduces the demand that can be served because it limits the intra-zone booking coverage.

A need therefore exists to provide methods and systems that seek to overcome or at least minimize the above mentioned challenges.

### SUMMARY

According to a first aspect of the present disclosure, there is provided a method for determining a zone for an area on a map, the method comprising: determining, by a processor, for an area on a map, one or more other areas on the map based on a plurality of trips between the area and each of the one or more areas, each of the area and the one or more other areas corresponding to at least one of a start location and an end location of at least one of the plurality of trips; and determining, by the processor, for the area, a corresponding zone based on a corresponding proportion of the plurality of trips between the area and each of the one or more other areas, the zone indicating an association of the area with at least one of the one or more other areas.

According to a second aspect of the present disclosure, there is provided a system for determining a zone for an area on a map, comprising: at least one processor; and at least one memory including computer program code; the at least one memory and the computer program code configured to, with the at least one processor, cause the system at least to: determine, for an area on a map, one or more other areas on the map based on a plurality of trips between the area and each of the one or more areas, each of the area and the one or more other areas corresponding to at least one of a start location and an end location of at least one of the plurality of trips; and determine, for the area, a corresponding zone based on a corresponding proportion of the plurality of trips between the area and each of the one or more other areas, the zone indicating an association of the area with at least one of the one or more other areas.

### BRIEF DESCRIPTION OF THE DRAWINGS

Embodiments and implementations are provided by way of example only, and will be better understood and readily apparent to one of ordinary skill in the art from the following written description, read in conjunction with the drawings, in which:

FIG. 1 illustrates a system for determining a zone for an area on a map according to various embodiments of the present disclosure.

FIG. 2 is a schematic diagram of a zone server, according to various embodiments of the present disclosure.

FIG. 3A depicts an illustration of a map according to an example.

FIG. 3B depicts an illustration of the map of FIG. 3A with a superimposed outermost geofence according to various embodiments of the present disclosure.

FIG. 3C depicts an illustration of a close-up view of a portion of the map of FIG. 3A with a superimposed geofence according to various embodiments of the present disclosure.

FIG. 4A depicts an illustration of the map of FIG. 3A with partitions according to various embodiments of the present disclosure.

FIG. 4B depicts an illustration of areas belonging to a cluster that are connected to each other according to various embodiments of the present disclosure.

FIG. 4C depicts an illustration of areas belonging to a cluster that are not connected to each other according to various embodiments of the present disclosure.

FIG. 5 depicts an illustration for calculating a relative distance between a pair of trips according to various embodiments of the present disclosure.

FIG. 6A illustrates the map of FIG. 3A with zones according to various embodiments of the present disclosure.

FIG. 6B illustrates a close-up view of a portion of the map of FIG. 6A with a zone comprising various separated portions according to various embodiments of the present disclosure.

FIG. 6C illustrates the close-up map view of FIG. 6B in which the various separated zone portions are merged according to various embodiments of the present disclosure

FIG. 7 illustrates an example flow diagram for determining a zone for an area on a map according to various embodiments.

FIG. 8A is a schematic block diagram of a general purpose computer system upon which the zone server of FIG. 2 can be practiced.

FIG. 8B is a schematic block diagram of a general purpose computer system upon which a combined transaction processing and zone server of FIG. 1 can be practiced.

FIG. 9 shows an example of a computing device to realize the transaction processing server shown in FIG. 1.

FIG. 10 shows an example of a computing device to realize the zone server shown in FIG. 1.

FIG. 11 shows an example of a computing device to realize a combined transaction processing and zone server shown in FIG. 1.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

### Terms Description

A platform refers to a set of technologies that is used as a base for facilitating exchanges between two or more interdependent servers, entities and/or devices, for example between a requestor device (e.g., associated with a requestor of a product or service) and a provider device (e.g., associated with a provider of the product or service). For example, a platform may offer a service offered by a provider such as a ride, delivery, online shopping, insurance, and other similar services to a requestor. A requestor can typically access the platform via a website, an application, or other similar methods using the requestor device. In the present disclosure, the provider device may be associated with a driver who may provide a ride or delivery that is requested by a requestor.

A location is one that a user may indicate or search for in a transport or delivery booking service. The location may be a place at which the user may be interested in going or delivering something (e.g., an end location of a trip made by a driver for a transport or delivery request of a user). It may also be a location at which the user wants to be picked up by a driver (e.g., a start location of a trip made by a driver for a transport or delivery request of a user) or at which the driver is to retrieve an item for a delivery. In a request for a driver that may be sent from the user to the transport or delivery booking service, a location at which the user wants to begin the ride or send a delivery may be indicated as the location. The location may be provided in the form of Global Positioning System (GPS) information, latitudinal and longitudinal coordinates, geohash information, and other similar information.

The start location and end location may be mapped to one or more areas (also referred to herein as cells or partition cells) on a map based on the associated GPS information, latitudinal and longitudinal coordinates, geohash information, and other similar information. Each area may be defined based on, for example, a city road network partition algorithm such as road cutting division (RCD) in which the map is divided into a plurality of grids based on existing roads, streets and boundaries on the map. In the present disclosure, the map can further be broken down into smaller grids with configurable parameters such as grid size, in particular for large areas without road information.

One or more areas on a map may be grouped together to form a cluster based on a plurality of trips that starts from and ends at the one or more areas, the cluster indicative of a demand pattern for ride and/or delivery requests among these one or more areas. The cluster may be determined based on a relative distance between each pair of the plurality of trips. Each area may belong to one or more clusters depending on the number of trips that start from and/or end at the area. Further, a zone may be determined for the area such that the zone indicates at least one of the one or more clusters for the area. The zone thus indicates an overlapping demand pattern that may be used for defining driver shift zones on the map. The zone may also be referred to herein as a shift zone, driver shift zone or service zone (e.g., a zone in which a driver may be stationed during his/her shift, and in which the driver provides a delivery or ride service within the zone during his/her shift).

In at least some embodiments, a user may be any suitable type of entity, which may include a person, a consumer looking to purchase a product or service via a transaction processing server, a seller or merchant looking to sell a product or service via the transaction processing server, a motorcycle driver or pillion rider in a case of the user looking to book or provide a motorcycle ride via the transaction processing server, a car driver or passenger in a case of the user looking to book or provide a car ride via the transaction processing server, and other similar entity. A user who is registered to the transaction processing server will be called a registered user. A user who is not registered to the transaction processing server will be called a non-registered user. The term user will be used to collectively refer to both registered and non-registered users. A user may interchangeably be referred to as a requestor (e.g., a person who requests for a product or service) or a provider (e.g., a person who provides the requested product or service to the requestor).

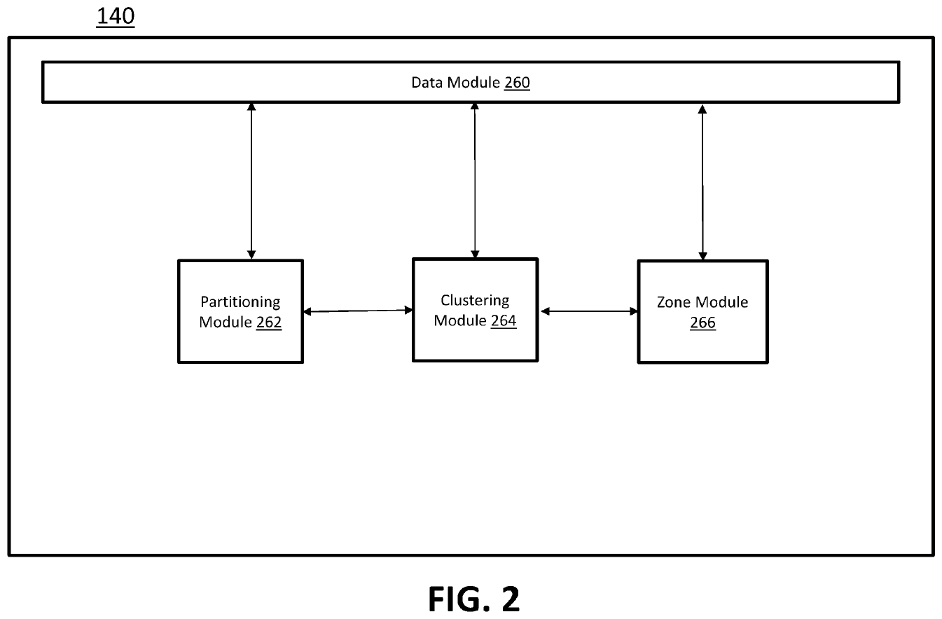

In at least some embodiments, a zone server is a server that hosts software application programs for determining a zone for an area on a map. The zone server may be implemented as shown in schematic diagram 200 of FIG. 2 for determining a zone for an area on a map.

In at least some embodiments, a transaction processing server is a server that hosts software application programs for processing payment transactions for, for example, a request for a driver, a travel-coordination request, purchasing of a good or service by a user, and other similar services. The transaction processing server communicates with any other servers (e.g., a zone server) concerning processing payment transactions relating to the purchasing of the good or service, such as a request for a driver (which may be referred to interchangeably as a request or booking for a ride, delivery, or other similar service that requires a driver). For example, data relating to a request message such as a request for a driver (e.g., date, time, a location, and other similar data) may be provided to the zone server and processed to locate drivers that are in proximity to a zone corresponding to the location. The transaction processing server may use a variety of different protocols and procedures in order to process the payment and/or driver requests.

Transactions that may be performed via a transaction processing server include product or service purchases, credit purchases, debit transactions, fund transfers, account withdrawals, etc. Transaction processing servers may be configured to process transactions via cash-substitutes, which may include payment cards, letters of credit, checks, payment accounts, etc.

In at least some embodiments, the transaction processing server is usually managed by a service provider that may be an entity (e.g., a company or organization) which operates to process transaction requests and/or driver requests e.g., pair a driver to a requestor of the driver request. The transaction processing server may include one or more computing devices that are used for processing transaction requests and/or driver requests.

In at least some embodiments, a transaction account is an account of a user who is registered at a transaction processing server. The user can be a customer, a merchant providing a product for sale on a platform and/or for onboarding the platform, a ride or delivery provider (e.g., a driver), or any third parties (e.g., a courier) who want to use the transaction processing server. In certain circumstances, the transaction account is not required to use the transaction processing server. A transaction account includes details (e.g., name, address, vehicle, face image, etc.) of a user. The transaction processing server manages the transaction.

Embodiments will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “identifying”, “detecting”, “grouping”, “determining”, “associating”, “selecting”, “calculating”, “processing”, “storing”, “indicating”, “clustering”, “partitioning”, “dividing”, or the like, refer to the action and processes of a computer system, or similar electronic device, that manipulates and transforms data represented as physical quantities within the computer system into other data similarly represented as physical quantities within the computer system or other information storage, transmission or display devices.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the scope of the specification.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

In the present disclosure, demand clustering algorithms and road network partition algorithms are utilized to design shift zones. Overlaps between zones are created (e.g., final zones are not mutually exclusive) such that the resultant zones would capture demand pattern for ride and delivery requests in the market and maximize intra-zone booking coverage. Further, boundaries are aligned with the road network for drivers to understand and navigate easily through their designated shift zone.

On a high level, there are 3 major phases of the present solution. In a first phase (e.g., road network partition) the map on which the zones are to be created is divided into smaller areas according to the city road network with minimum impact on expressways, rivers etc based on local context. In a second phase (e.g., hierarchical clustering), each trip that is made by a driver for a ride or delivery request is mapped onto one or more corresponding areas on the map. For example, each of a start location of the trip and an end location of the trip is mapped to a corresponding area on the map based on GPS information, latitudinal and longitudinal coordinates, geohash information, and other similar information of the start and end location. A pair of area(s) mapped to a start location and an end location of a trip may be referred to herein as a pick up (PU) and drop off (DO) pair. It will be appreciated that the area corresponding to a start location of a trip may be the same as the area corresponding to an end location of the trip. Based on a plurality of trips made by drivers within the vicinity of the map for ride or delivery bookings, a plurality of PU-DO pairs may be created and clustered to maximize intra-zone booking coverage according to trip similarity using hierarchical clustering. For this clustering, a custom distance formula is proposed as the key to evaluate the distance and dispersion between any two trips (e.g., a trip pair). In a third phase, areas that should belong to multiple zones are identified to create overlapping areas, so to further maximize the intra-zone demand, with configurable hyperparameters to adjust the degree of overlap depending on market requirement. Thus, the present solution may be summarized into the following steps: (1) get demand data (e.g., plurality of PU-DO pairs) for a target geographical boundary (e.g., a city); (2) create PU and DO pairs based on a geographic partition (e.g., geohash, road partitioning, and other similar methods); (3) get initial clusters for each PU-DO pair; (4) create zones by setting hyperparameters (e.g., a minimum proportion of trips, a maximum rank, and other similar thresholds) to determine a degree of overlap between clusters.

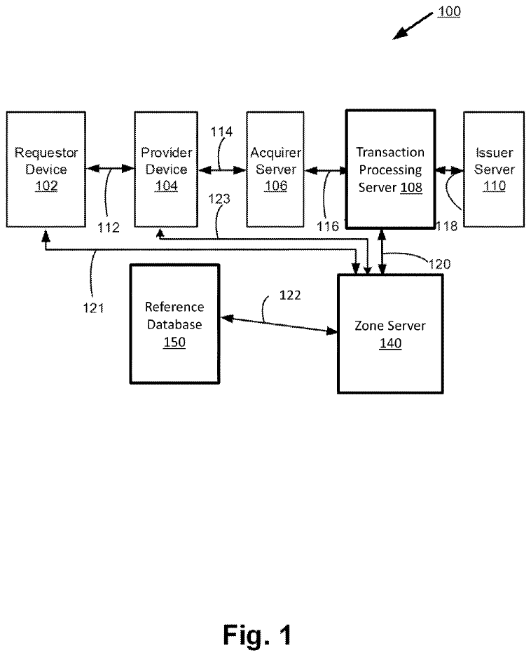

FIG. 1 illustrates a block diagram of an example system 100 for determining a zone for an area on a map. In some embodiments, the system 100 enables a payment transaction for a good or service, and/or a request for a driver e.g., for a ride or delivery of a physical item (e.g., one or more food items or a parcel) between a requestor and a provider.

The system 100 comprises a requestor device 102, a provider device 104, an acquirer server 106, a transaction processing server 108, an issuer server 110, a zone server 140 and a reference database 150.

The requestor device 102 is in communication with a provider device 104 via a connection 112, and may be associated with a user. The connection 112 may be wireless (e.g., via NFC communication, Bluetooth, etc.) or over a network (e.g., the Internet). The requestor device 102 is also in communication with the zone server 140 via a connection 121, wherein the zone server 140 may be configured to receive information relating to a request for a driver (e.g., information such as a location at which a driver is required, information identifying the user and/or requestor device 102 sending the request, and other similar information) from the requestor device 102. The connection 121 may be via a network (e.g., the Internet). The requestor device 102 may also be connected to a cloud that facilitates the system 100 for determining a zone for an area on a map. For example, the requestor device 102 can send a signal or data to the cloud directly via a wireless connection (e.g., via NFC communication, Bluetooth, etc.) or over a network (e.g., the Internet). It will be appreciated that there can be a plurality of requestor devices 102 such that each requestor device 102 is associated with a respective user.

The provider device 104 is in communication with the requestor device 102 as described above, usually via the transaction processing server 108, and may be associated with a provider of a ride or delivery (e.g., a driver responding to the request for a driver). The provider device 104 is, in turn, in communication with an acquirer server 106 via a connection 114. The provider device 104 is also in communication with the zone server 140 via a connection 123, wherein the zone server 140 may be configured to receive information relating to a location of a driver (e.g., GPS information, latitudinal and longitudinal coordinates, geohash information, or other similar information), a status of the driver (e.g., available, unavailable, handling another request, finishing a request soon, or other similar statuses), identification information relating to the driver and/or provider device 104, and other similar information from the provider device 104. The connections 114 and 123 may be via a network (e.g., the Internet). The provider device 104 may also be connected to a cloud that facilitates the system 100 for determining a zone for an area on a map. For example, the provider device 104 can send a signal or data to the cloud directly via a wireless connection (e.g., via NFC communication, Bluetooth, etc.) or over a network (e.g., the Internet). It will be appreciated that there can be a plurality of provider devices 104 such that each provider device 104 is associated with a respective driver.

The acquirer server 106, in turn, is in communication with the transaction processing server 108 via a connection 116. The transaction processing server 108, in turn, is in communication with an issuer server 110 via a connection 118. The connections 116 and 118 may be via a network (e.g., the Internet).

The transaction processing server 108 is further in communication with the zone server 140 via a connection 120. The connection 120 may be over a network (e.g., a local area network, a wide area network, the Internet, etc.). In one arrangement, the transaction processing server 108 and the zone server 140 are combined and the connection 120 may be an interconnected bus.

The zone server 140, in turn, is in communication with the reference database 150 via respective connection 122. The connection 122 may be over a network (e.g., the Internet). The zone server 140 may also be connected to a cloud that facilitates the system 100 for determining a zone for an area on a map. For example, the zone server 140 can send a signal or data to the cloud directly via a wireless connection (e.g., via NFC communication, Bluetooth, etc.) or over a network (e.g., the Internet).

The reference database 150 may comprise data that is utilized by the zone server 140 for determining a zone for an area on a map. For example, data relating to the map, grid overlay for dividing the map into areas, information relating to trip bookings on the map (e.g., GPS information, latitudinal and longitudinal coordinates, geohash information, or other similar information relating to a start location and end location of each trip on the map), map dividing algorithm, area clustering algorithm, overlapping zone creation algorithm, and other similar information required for determining a zone for an area on a map may be processed and stored in the reference database 150. The reference database 150 may also comprise data such as location information relating to geographical areas, buildings, road networks, boundaries, and other similar entities that may facilitate determining a zone for an area on a map. In an implementation, the reference database 150 may be combined with the zone server 140. In an example, the reference database 150 may be managed by an external entity.

The zone server 140 may be configured to determine, for an area on a map, one or more other areas on the map based on a plurality of trips between the area and each of the one or more areas, each of the area and the one or more other areas corresponding to at least one of a start location and an end location of at least one of the plurality of trips. The zone server 140 may also determine, for the area, a corresponding zone based on a corresponding proportion of the plurality of trips between the area and each of the one or more other areas, the zone indicating an association of the area with at least one of the one or more other areas.

In an implementation, there may be more than one reference database, in which the zone server 140 may be configured to determine which database to use for each step during the process of determining a zone for an area on a map. Alternatively, one or more modules may store the above-mentioned data instead of the reference database 150, wherein the module may be integrated as part of the zone server 140 or external from the zone server 140.

In the illustrative embodiment, each of the devices 102, 104, and the servers 106, 108, 110, 140, and/or reference database 150 provides an interface to enable communication with other connected devices 102, 104 and/or servers 106, 108, 110, 140, and/or reference database 150. Such communication is facilitated by an application programming interface (“API”). Such APIs may be part of a user interface that may include graphical user interfaces (GUIs), Web-based interfaces, programmatic interfaces such as application programming interfaces (APIs) and/or sets of remote procedure calls (RPCs) corresponding to interface elements, messaging interfaces in which the interface elements correspond to messages of a communication protocol, and/or suitable combinations thereof. For example, it is possible for the requestor device 102 to send data relating to a request for a driver such as a location at which the driver is required, and for the provider device 104 to send data relating to a location or a status of an associated driver, in response to an enquiry shown on the GUI running on the respective API.

Use of the term ‘server’ herein can mean a single computing device or a plurality of interconnected computing devices which operate together to perform a particular function. That is, the server may be contained within a single hardware unit or be distributed among several or many different hardware units.

The zone server 140 is associated with an entity (e.g., a company or organization or moderator of the service). In one arrangement, the zone server 140 is owned and operated by the entity operating the transaction processing server 108. In such an arrangement, the zone server 140 may be implemented as a part (e.g., a computer program module, a computing device, etc.) of the transaction processing server 108.

The transaction processing server 108 may also be configured to manage the registration of users. A registered user has a transaction account (see the discussion above) which includes details of the user. The registration step is called on-boarding. A user may use either the requestor device 102 or the provider device 104 to perform on-boarding to the transaction processing server 108.

It may not be necessary to have a transaction account at the transaction processing server 108 to access the functionalities of the transaction processing server 108. However, there are functions that are available to a registered user. These additional functions will be discussed below.

The on-boarding process for a user is performed by the user through one of the requestor device 102 or the provider device 104. In one arrangement, the user downloads an app (which includes the API to interact with the transaction processing server 108) to the requestor device 102 or the provider device 104. In another arrangement, the user accesses a website (which includes the API to interact with the transaction processing server 108) on the requestor device 102 or the provider device 104. The user is then able to interact with the zone server 140. The user may be a requestor or a provider associated with the requestor device 102 or the provider device 104, respectively.

Details of the registration may include, for example, name of the user, address of the user, emergency contact, blood type or other healthcare information, next-of-kin contact, permissions to retrieve data and information from the requestor device 102 and/or the provider device 104 for determining a zone for an area on a map, such as permission to retrieve location and status information from the requestor device 102 and/or the provider device 104. Alternatively, another mobile device may be selected instead of the requestor device 102 and/or the provider device 104 for retrieving the data. Once on-boarded, the user would have a transaction account that stores all the details.

The requestor device 102 is associated with a user (or requestor) who is a party to a transaction that occurs between the requestor device 102 and the provider device 104, or between the requestor device 102 and the zone server 140. The requestor device 102 may be a computing device such as a desktop computer, an interactive voice response (IVR) system, a smartphone, a laptop computer, a personal digital assistant computer (PDA), a mobile computer, a tablet computer, and the like. The requestor device 102 may be associated with a user who initiates a request for a driver.

The requestor device 102 includes transaction credentials (e.g., a payment account) of a requestor to enable the requestor device 102 to be a party to a payment transaction. If the requestor has a transaction account, the transaction account may also be included (e.g., stored) in the requestor device 102. For example, a mobile device (which is a requestor device 102) may have the transaction account of the customer stored in the mobile device.

In one example arrangement, the requestor device 102 is a computing device in a watch or similar wearable and is fitted with a wireless communications interface (e.g., a NFC interface). The requestor device 102 can then electronically communicate with the provider device 104 regarding a transaction request. The user uses the watch or similar wearable to make request regarding the transaction request by pressing a button on the watch or wearable.

The provider device 104 is associated with a provider who is also a party to the transaction request or request for a driver that occurs between the requestor device 102 and the provider device 104. The provider device 104 may be a computing device such as a desktop computer, an interactive voice response (IVR) system, a smartphone, a laptop computer, a personal digital assistant computer (PDA), a mobile computer, a tablet computer, and the like. The provider device 104 may be associated with a provider of a ride or delivery (e.g., a driver responding to the request for a driver).

Hereinafter, the term “provider” refers to a service provider and any third party associated with providing a product or service for purchase, or a travel or ride or delivery service via the provider device 104. Therefore, the transaction account of a provider refers to both the transaction account of a provider and the transaction account of a third party (e.g., a driver, travel co-ordinator or merchant) associated with the provider.

If the provider has a transaction account, the transaction account may also be included (e.g., stored) in the provider device 104. For example, a mobile device (which is a provider device 104) may have the transaction account of the provider stored in the mobile device.

In one example arrangement, the provider device 104 is a computing device in a watch or similar wearable and is fitted with a wireless communications interface (e.g., a NFC interface). The provider device 104 can then electronically communicate with the requestor to make request regarding the transaction request by pressing a button on the watch or wearable.

The acquirer server 106 is associated with an acquirer who may be an entity (e.g., a company or organization) which issues (e.g., establishes, manages, administers) a payment account (e.g., a financial bank account) of a merchant. Examples of the acquirer include a bank and/or other financial institution. As discussed above, the acquirer server 106 may include one or more computing devices that are used to establish communication with another server (e.g., the transaction processing server 108) by exchanging messages with and/or passing information to the other server. The acquirer server 106 forwards the payment transaction relating to a transaction request or a request for a ride to the transaction processing server 108.

The transaction processing server 108 is configured to process processes relating to a transaction by, for example, forwarding data and information associated with the transaction to the other servers in the system 100 such as the zone server 140. In an example, the transaction processing server 108 may, instead of the requestor device 102 or provider device 104, transmit data relating to a request message such as a request for a driver (e.g., date, time, a location, and other similar data) to the zone server 104. The transaction processing server 108 may use a variety of different protocols and procedures in order to process the payment and/or travel co-ordination requests. It will be appreciated that payment for a transaction may be made via a variety of methods such as credit cards, debit cards, digital wallets, buy-first pay-later schemes, and other similar payment methods.

The issuer server 110 is associated with an issuer and may include one or more computing devices that are used to perform a payment transaction. The issuer may be an entity (e.g., a company or organization) which issues (e.g., establishes, manages, administers) a transaction credential or a payment account (e.g., a financial bank account) associated with the owner of the requestor device 102. As discussed above, the issuer server 110 may include one or more computing devices that are used to establish communication with another server (e.g., the transaction processing server 108) by exchanging messages with and/or passing information to the other server.

The reference database 150 is a database or server associated with an entity (e.g., a company or organization) which manages (e.g., establishes, administers) data relating to users, transactions, products, services, and other similar data, for example relating to the entity. In an arrangement, the reference database 150 may comprise data that is utilized by the zone server 140 for determining a zone for an area on a map. For example, data relating to the map, grid overlay for dividing the map into areas, information relating to trip bookings on the map (e.g., GPS information, latitudinal and longitudinal coordinates, geohash information, or other similar information relating to a start location and end location of each trip on the map), map dividing algorithm, area clustering algorithm, overlapping zone creation algorithm, and other similar information required for determining a zone for an area on a map may be processed and stored in the reference database 150. The reference database 150 may also comprise data such as location information relating to geographical areas, buildings, road networks, boundaries, and other similar entities that may facilitate determining a zone for an area on a map. In an implementation, the reference database 150 may be combined with the zone server 140. In an example, the reference database 150 may be managed by an external entity.

Advantageously, the system 100 enables optimal capturing of market demand patterns relating to trip and delivery bookings and increases drivers' navigation efficiency. The enhanced shift zones also enable improved capturing of demand for intra-zone bookings.

FIG. 2 illustrates a schematic diagram of an example zone server 140 according to various embodiments. The zone server 140 may comprise a data module 260 configured to receive data and information from the requestor device 102, provider device 104, transaction processing server 108, reference database 150, a cloud and other sources of information to determine a zone for an area on a map by the zone server 140. For example, the data module 260 may be configured to receive data and information required for dividing a map into a plurality of areas, determining one or more areas on the map associated with a plurality of trips, perform calculations of distances relating to the plurality of trips, defining a zone for each area of the map, and other similar processes from the requestor device 102, the provider device 104, transaction processing server 108, reference database 150, and/or other sources of information. The data module 260 may be further configured to send information relating to data retrieved in response to the request for a driver to the requestor device 102, the provider device 104, the transaction processing server 108, or other destinations where the information is required.

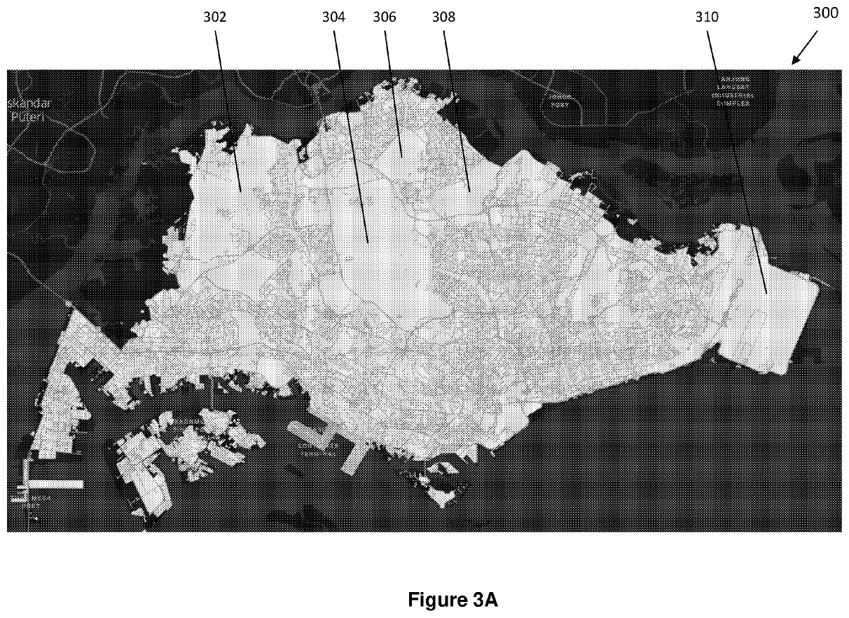

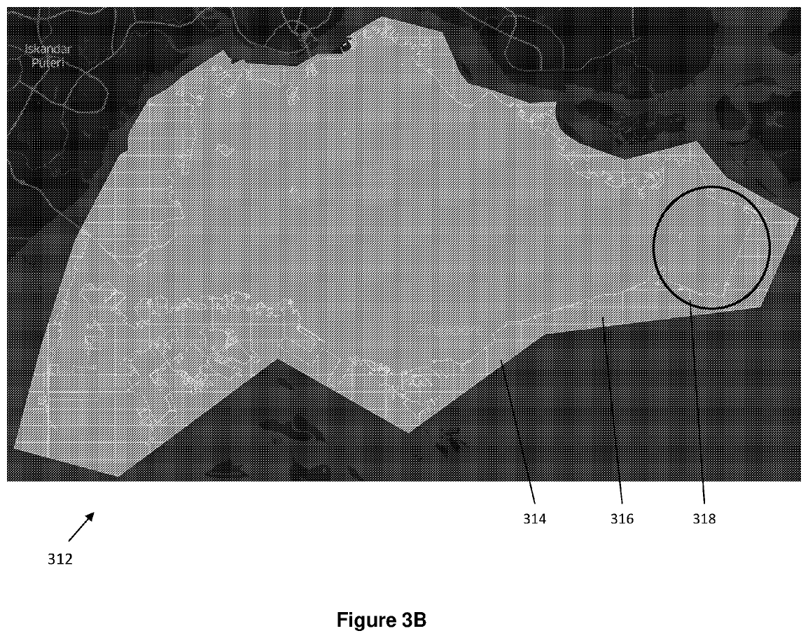

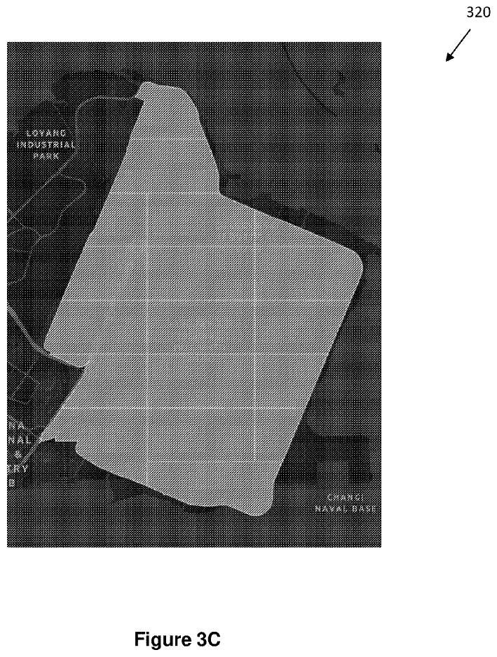

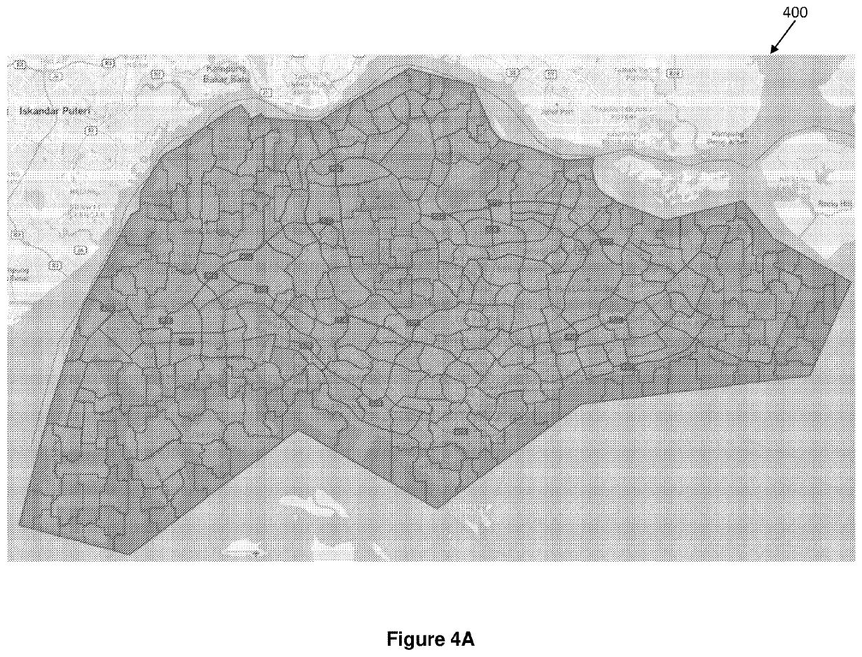

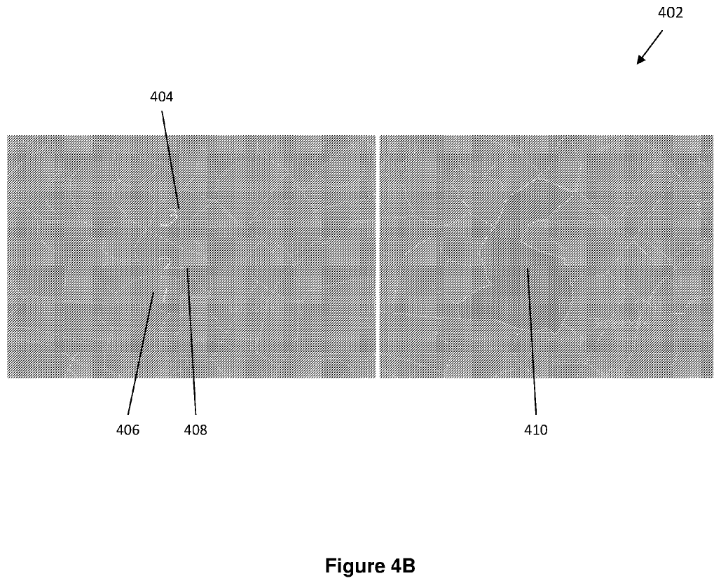

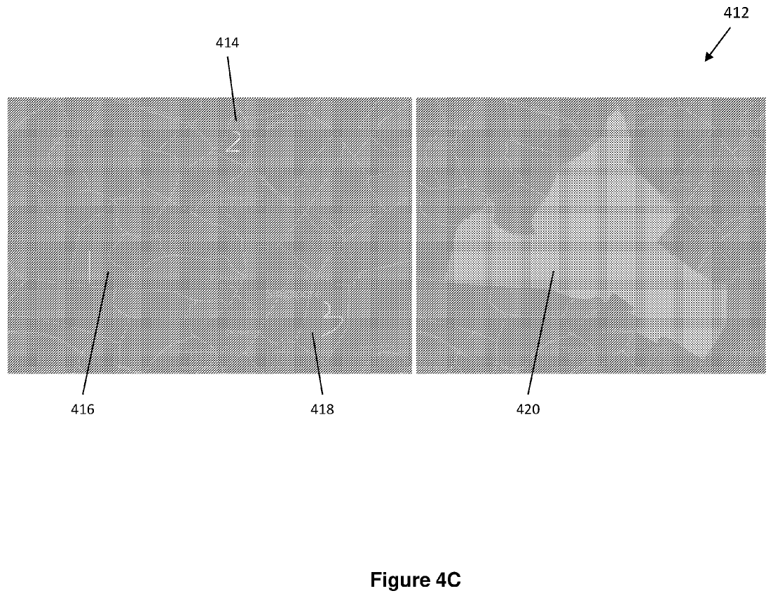

The zone server 140 may comprise a partitioning module 262 that is configured for dividing a map into a plurality of areas. For example, the partitioning module 262 may be configured to overlay a plurality of gridlines over the map, each gridline representing a virtual boundary, road or street on the map; and divide the map into the plurality of areas based on the plurality of gridlines. The dividing process is further explained in FIGS. 3A-4A.

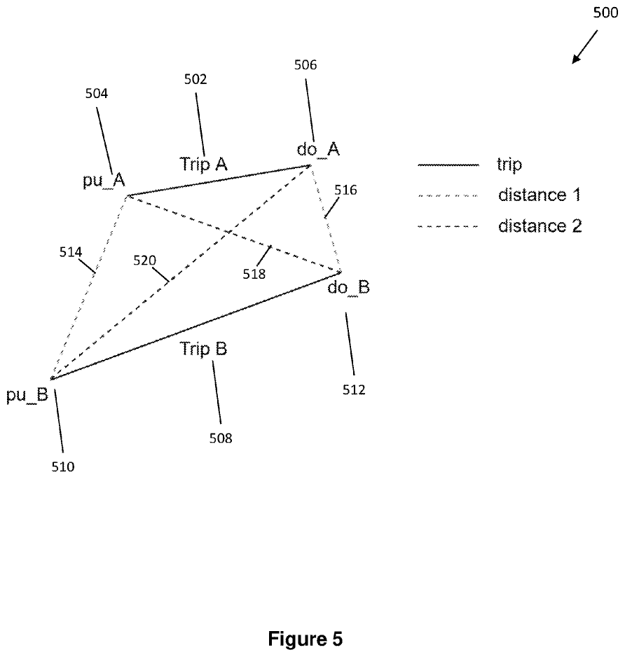

The zone server 140 may also comprise a clustering module 264 that is configured for determining, for an area on a map, one or more other areas on the map based on a plurality of trips between the area and each of the one or more areas, each of the area and the one or more other areas corresponding to at least one of a start location and an end location of at least one of the plurality of trips. In an implementation, the clustering module 264 may be further configured to calculate a first distance, the first distance being a summation of a distance between a start location of a first trip of the plurality of trips and a start location of a second trip of the plurality of trips and a distance between an end location of the first trip and an end location of the second trip, the first trip being between the area and a first other area, and the second trip being between the area and a second other area; calculate a second distance, the second distance being a summation of a distance between the start location of the first trip and the end location of the second trip and a distance between the end location of the first trip and the start location of the second trip; determine a shorter distance of the first and second distance; and cluster the area, the first other area and the second other area together based on the determined shorter distance. Determining the area and the one or more other areas may be based on latitudinal and longitudinal coordinates of the start location and stop location of each of the plurality of trips. The clustering process is further explained in FIGS. 4B, 4C and 5.

The zone server 140 may also comprise a zone module 266 that is configured for determining, for the area, a corresponding zone based on a corresponding proportion of the plurality of trips between the area and each of the one or more other areas, the zone indicating an association of the area with at least one of the one or more other areas. In an implementation, the zone module 266 may be configured to: calculate a total number of the plurality of trips associated with the area, and a corresponding total number of trips between the area and each of the one or more other areas; calculate, for each of the one or more other areas, the corresponding proportion based on the total number of the plurality of trips and the corresponding total number of trips between the area and each of the one or more other areas; and determine a rank for each of the one or more other areas based on the calculated proportion. In an implementation, determining the corresponding zone may be based on a minimum proportion, wherein the corresponding zone indicates only an association between the area and one or more other areas with the calculated proportion that is equal to or exceeds the minimum proportion. In an implementation, determining the corresponding zone may be based on a maximum rank, wherein the corresponding zone indicates only an association between the area and one or more other areas with the determined rank that is equal to or lower than the maximum rank.

Each of the data module 260, partitioning module 262, clustering module 264 and zone module 266 may further be in communication with a processing module (not shown) of the zone server 140, for example for coordination of respective tasks and functions during the process. The data module 260 may be further configured to communicate with and store data and information for each of the processing modules, partitioning module 262, clustering module 264 and zone module 266. Alternatively, all the tasks and functions required for adaptively determining a zone for an area on a map may be performed by a single processor of the zone server 140.

FIG. 3A depicts an illustration of a map 300 of a city in which, for example, a plurality of trips had been made to fulfill a plurality of ride and/or delivery requests. The map 300 may be effectively divided into a plurality of areas based on a road network partition algorithm. Each area may be customized with configurable parameters such as, for example, grid size. An example of a road network partition algorithm may be RCD or other similar algorithm. The road network partition algorithm may be further developed and tailored to implement zones in accordance with the present disclosure. For example, a plurality of grid lines may be introduced as an overlay on the map, wherein each of the plurality of grid lines simulates a virtual boundary, road or street on the map. The plurality of grid lines advantageously breaks down large areas without road information (e.g., forest, reservoir, and other similar areas) to provide a finer granularity of the map and to fill up gaps between actual geographical city boundary and outermost roads on the map. Further, a merging mechanism may be introduced to merge one or more areas into clusters that may be generated based on demand patterns (e.g., based on information relating to a plurality of trips that are made in the one or more areas), and further determining a zone for each area in the map while preserving the alignment with the road network, wherein each zone may indicate an association of the area with each of one or more other areas (e.g., indicating one or more clusters associated with the area). API endpoints may be introduced to provide the various functionalities required for implementing the overlays and merging mechanism as described above, allowing for ease of access and integration with existing road network partitioning algorithms.

There are large undivided areas in the map 300 as shown by references 302, 304, 306, 308 and 310 due to a lack of road information within these areas, which produces large partition inequality (while most partitions are small, these large areas cannot not be further broken down); also, due to a lack of city boundary information for the map 300, there are noticeable amounts of area geographically within the city represented by the map 300 but not included in the map. A plurality of grid lines may be overlayed on the map 300 to further break down the larger areas as if there are “virtual roads” along the grid lines. The size of the virtual grids may be configurable to provide flexibility to adjust the partition granularity depending on the actual application. In addition, the plurality of gridlines may superimpose an outermost geofence as a defined boundary to include all necessary area that was not covered by the map 300 (e.g., due to a lack of map information), and also creates partitions within the gap(s), for example as shown in map 312 of FIG. 3B. A plurality of gridlines is overlayed on the map 312 resulting in an outer geofence 314 around the map. FIG. 3B shows an example of a map 312 after implementation of the gridlines overlay on map 300. The plurality of gridlines define a plurality of grids such as grid 316. Each grid of the plurality of grids on the map may correspond to an area of a plurality of areas on the map. While the grid 316 is rectangular in shape, it will be appreciated that other shapes (e.g., circle, square, polygonal, irregularly-shaped, and other similar shapes) are also possible. It is possible to break down large areas without road information using the plurality of gridlines. For example, portion 318 of the map 312 may be further divided into a plurality of gridlines by the gridline overlay, such as shown in map 320 of FIG. 3C.

Map 400 of FIG. 4A is an example of a resultant partition map after an overlay of gridlines which possesses better partition equality and corrects for the area leakage problem of the original RCD algorithm. In the map 400, every partition cell (e.g., modelled based on an overlay of a plurality of gridlines and existing map information) is independent and mutually exclusive of each other, and represents an area of a plurality of areas on the map. In a later step of clustering these cells, cells belonging to the same cluster may or may not be connected to each other. For example, referring to illustration 402 of FIG. 4B, cells 404, 406 and 408 belong to the same cluster 410 and are connected to one another. In another example, referring to illustration 412 of FIG. 4C, cells 414, 416 and 418 belong to the same cluster 420 but are not connected to one another. A shortest path merging algorithm may be implemented to facilitate merging the cells in the same cluster to output a final continuous zone regardless of whether partitions in the same cluster are adjacent. Furthermore, one or more APIs configured to perform the above-mentioned overlay and clustering may be developed for ease of accessibility.

Having the map broken down into a plurality of areas, the next problem is how to cluster the areas such that the collection of areas, e.g., a shift zone, captures the market demand pattern relating to the plurality of trips and captures maximized intra-zone trips. A hierarchical clustering algorithm may be implemented with the flexibility to adjust the number of clusters by, for example, further breaking down a large cluster. For example, a partitioned map (e.g., map 400) may be generated based on the above mentioned overlay of a plurality of gridlines on a map. Based on a starting location and an end location of each trip on the map, a partition pair consisting of a PU partition and a DO partition may be determined for each trip, for example based on latitudinal and longitudinal coordinates of the starting location and end location, and the partition boundary geometries.

Each PU-DO partition pair may be clustered with one or more other PU-DO partition pairs based on hierarchical clustering with a pairwise custom distance metric. For example, referring to illustration 500 of FIG. 5, a first distance may be calculated based on a formula distance 1=LineDist(pu_A, pu_B)+LineDist(do_A, do_B). Accordingly, the first distance is a summation of a distance 514 between a start location 504 of a first trip 502 and a start location 510 of a second trip 408 and a distance 516 between an end location 506 of the first trip 502 and an end location 512 of the second trip 508. The first trip 502 may be between an area and a first other area, and the second trip 508 may be between the area and a second other area. The first other area and the second other area may be the same or different from the area. A second distance may be calculated based on a formula distance 2=LineDist (pu_A, do_B)+LineDist (pu_A, do_B). Accordingly, the second distance is a summation of a distance 518 between the start location 504 of the first trip 502 and the end location 512 of the second trip 508 and a distance 520 between the end location 506 of the first trip 502 and the start location 510 of the second trip 508. Thereafter, a shorter distance of the first and second distance is determined, for example via a formula Custom distance=minimum (distance 1, distance 2). Based on the determined shorter distance (e.g., a comparison of the determined shorter distance with a threshold such as a minimum distance, or other similar methods), the area, the first other area and the second other area may be clustered together. Considering both the first distance and the second distance advantageously removes the directional relationship of a trip pair (e.g., trip 502 and trip 508) in the sense that trip pairs heading to either the same direction or an opposite direction should not be different in terms of pairwise distance. It will be appreciated that there may be a plurality of each of the first trip and the second trip (e.g., trips having a same start location and end location of the first trip and the second trip), such that each trip is made for a corresponding booking e.g., a trip or delivery booking by a user.

Based on the pairwise custom distance metric, one or more clusters in the form of PU-DO partition pairs may be created and each PU-DO partition pair may be assigned a label e.g., a cluster label. It is possible for an area associated with a PU-DO partition pair to belong to multiple clusters, which provides the possibility of creating overlaps between clusters which will be captured during determination of a zone for the area. After the above clustering, the following steps may be conducted to determine a zone for the area. Based on initial clustering results of the PU-DO partition pairs, a number of trips or bookings associated with each PU-DO partition pair are calculated.

TABLE 1

| pickup | dropoff | cluster | |
|---|---|---|---|
| partition | partition | label | trips |
| A | A | 1 | 300 |
| A | B | 1 | 500 |
| C | A | 2 | 500 |
| D | A | 3 | 300 |

For example referring to table 1 listing all PU-DO partition pairs that are associated with an area A (e.g., having a start location and/or an end location at area A), a first PU-DO partition pair with both a start and end location at area A has a cluster label 1 and 300 trips (e.g., the first PU-DO partition pair comprises 300 trips within the area A). A second PU-DO partition pair with a start location at area A and end location at an area B also has a cluster label 1 (e.g., the first and second PU-DO partition pair belong to the same cluster) and 500 bookings. Further, a third PU-DO partition pair with a start location at an area C and an end location at area A has a cluster label 2 and 500 trips, and a fourth PU-DO partition pair with a start location at an area D and an end location at area A has a cluster label 1 and 300 trips. Based on the above information, the number of bookings are aggregated for area A as shown in table 2 below.

TABLE 2

| | | | partition trips per | |
|---|---|---|---|---|
| partition | cluster | trips | cluster proportion | rank |
| A | 1 | 800 | 0.5 | 1 |
| A | 2 | 500 | 0.32 | 2 |
| A | 3 | 300 | 0.19 | 3 |

For cluster 1, it is determined that there are 800 trips having at least a start and/or end location in area A (e.g., summation of the number of trips associated with the first PU-DO pair and the second PU-DO pair of cluster 1). For cluster 2 and 3, there are 500 trips and 300 trips respectively that have at least one of a start or end location in area A. A total number of the plurality of trips associated with area A may be calculated (e.g., a total of 1600 trips associated with area A). Further, for each of the clusters 1, 2 and 3 (e.g., cluster 1 associated with area A and B, cluster 2 associated with area A and C, cluster 3 associated with area A and D), a corresponding total number of trips may be calculated. Based on the total number of the plurality of trips associated with area A and the corresponding total number of trips for each cluster 1, 2 and 3, a corresponding proportion of trips may be calculated for each cluster e.g., a corresponding proportion based on the total number of the plurality of trips and the corresponding total number of trips between the area A and each of the areas A (first PU-DO partition pair), B (second PU-DO partition pair), C (third PU-DO partition pair) and D (fourth PU-DO partition pair). Further, a rank may be determined for each cluster based on the calculated proportion. For example, in table 2, cluster 1 has 800 trips, thus a proportion of 0.5 (e.g., out of a total of 1600 trips associated with area A) and a rank of 1 (e.g., a highest rank due to having a highest proportion of trips for the area A). Cluster 2 has 500 trips, thus a proportion of 0.32 and a rank of 2. Further, cluster 3 has 300 trips, thus a proportion of 0.19 and a rank of 3 (e.g., a lowest rank due to having a lowest proportion of trips for the area A). A threshold value may be set to determine a degree of overlapping among the clusters for area A, for example as shown in table 3 below.

TABLE 3

| max rank | min proportion | area A's clusters |
|---|---|---|
| 2 | 0.4 | 1 |
| 2 | 0.3 | 1, 2 |
| 3 | 0.2 | 1, 2 |
| 3 | 0.1 | 1, 2, 3 |

For example, a maximum rank and/or a minimum proportion may be implemented. A higher maximum rank correlates to a higher number of permissible clusters for area A, thus creating more overlaps among the clusters 1, 2 and 3. A minimum proportion correlates to a minimum number of trips required within a cluster in order for the area A to be assigned the cluster, such that a lower minimum proportion creates more overlaps. Referring to table 3, a maximum rank of 2 and a minimum proportion of 0.4 would mean that area A will only be assigned to cluster 1 (e.g., a zone for area A only indicates an association of area A with area B). A maximum rank of 2 and a minimum proportion of 0.3 would mean that area A will be assigned to clusters 1 and 2 (e.g., the zone for area A only indicates an association of area A with area B and area C). A maximum rank of 3 and a minimum proportion of 0.2 would mean that area A will be assigned to clusters 1 and 2 (e.g., the zone for area A only indicates an association of area A with area B and area C). Further, a maximum rank of 3 and a minimum proportion of 0.1 would mean that area A will be assigned to clusters 1, 2 and 3 (e.g., the zone for area A indicates an association of area A with areas B, C and D).

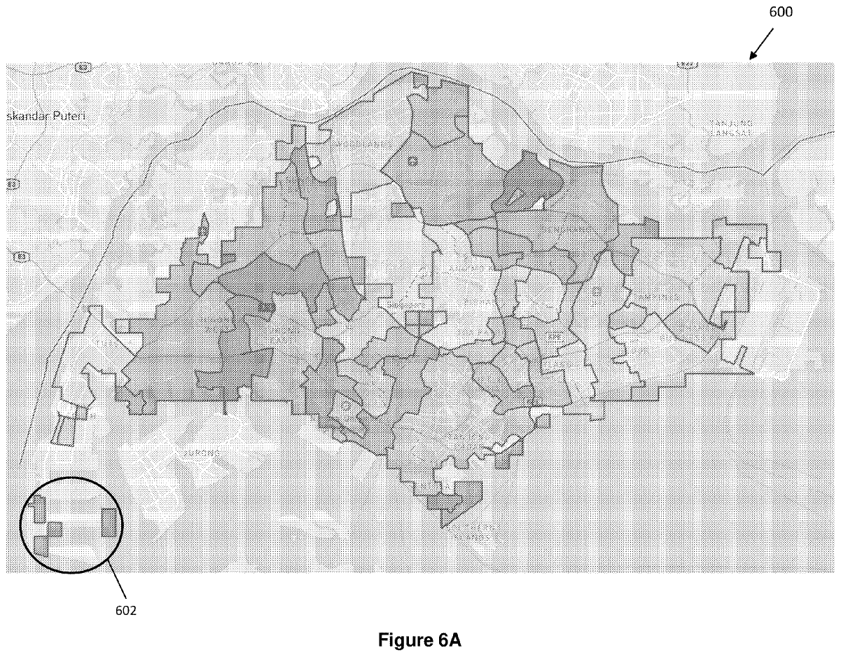

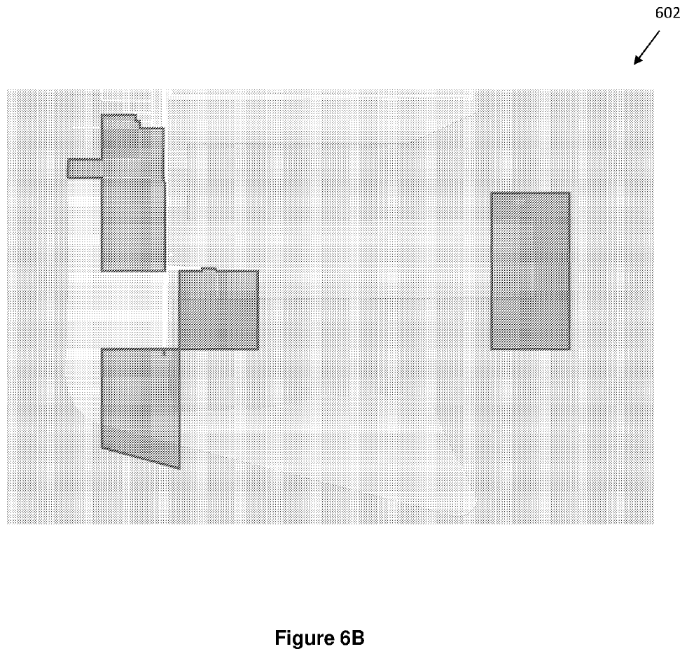

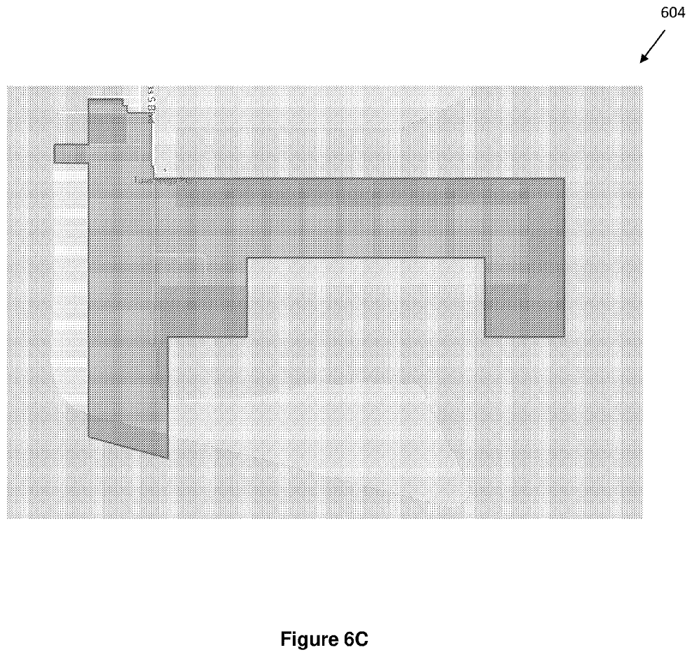

As such, a zone indicating overlaps among associated clusters for each area on a map may be determined and created, for example as shown in map 600 of FIG. 6A. Each zone on a map may be configured to be of a different colour if the map 600 is displayed to a driver to improve clarity. While some zones on the map 600 may consist of multiple polygons e.g., as shown in illustration 602 of FIG. 6B, it is possible to implement a further merge and post processing based on a shortest path merging solution to merge the zones together, for example as shown in illustration 604 of FIG. 6C. Thus, the created zones may be utilized for designating an appropriate number of drivers for each zone, to efficiently address ride and delivery booking demands associated with each zone.

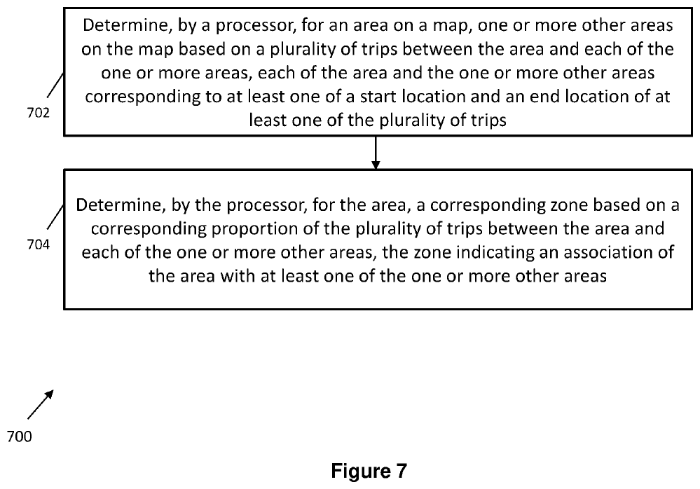

FIG. 7 illustrates an example flow diagram for a method 700 for determining a zone for an area on a map according to various embodiments. In a step 702, it is determined, by a processor, for an area on a map, one or more other areas on the map based on a plurality of trips between the area and each of the one or more areas, each of the area and the one or more other areas corresponding to at least one of a start location and an end location of at least one of the plurality of trips. In a step 704, it is determined, by the processor, for the area, a corresponding zone based on a corresponding proportion of the plurality of trips between the area and each of the one or more other areas, the zone indicating an association of the area with at least one of the one or more other areas.

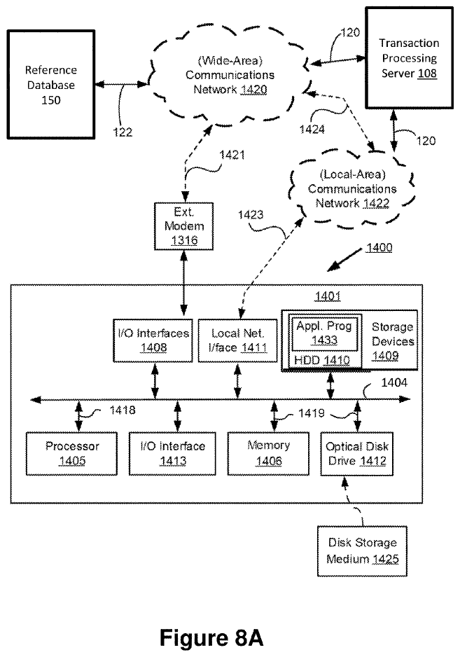

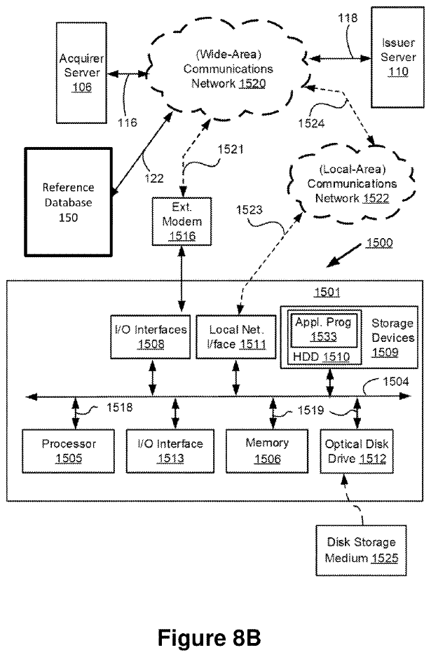

FIG. 8A depict an example computer system 1400, in accordance with which the zone server 140 described can be practiced. The computer system 1400 includes a computer module 1401. An external Modulator-Demodulator (Modem) transceiver device 1416 may be used by the computer module 1401 for communicating to and from a communications network 1420 via a connection 1421. The communications network 1420 may be a wide-area network (WAN), such as the Internet, a cellular telecommunications network, or a private WAN. Where the connection 1421 is a telephone line, the modem 1416 may be a traditional “dial-up” modem. Alternatively, where the connection 1421 is a high capacity (e.g., cable) connection, the modem 1416 may be a broadband modem. A wireless modem may also be used for wireless connection to the communications network 1420.

The computer module 1401 typically includes at least one processor unit 1405, and a memory unit 1406. For example, the memory unit 1406 may have semiconductor random access memory (RAM) and semiconductor read only memory (ROM). The computer module 1401 also includes an interface 1408 for the external modem 1416. In some implementations, the modem 1416 may be incorporated within the computer module 1401, for example within the interface 1408. The computer module 1401 also has a local network interface 1411, which permits coupling of the computer system 1400 via a connection 1423 to a local-area communications network 1422, known as a Local Area Network (LAN). As illustrated in FIG. 8A, the local communications network 1422 may also couple to the wide network 1420 via a connection 1424, which would typically include a so-called “firewall” device or device of similar functionality. The local network interface 1411 may comprise an Ethernet circuit card, a Bluetooth® wireless arrangement or an IEEE 802.11 wireless arrangement; however, numerous other types of interfaces may be practiced for the interface 1411.

The I/O interfaces 1408 may afford either or both of serial and parallel connectivity, the former typically being implemented according to the Universal Serial Bus (USB) standards and having corresponding USB connectors (not illustrated). Storage devices 1409 are provided and typically include a hard disk drive (HDD) 1410. Other storage devices such as a floppy disk drive and a magnetic tape drive (not illustrated) may also be used. An optical disk drive 1412 is typically provided to act as a non-volatile source of data. Portable memory devices, such optical disks, USB-RAM, portable, external hard drives, and floppy disks, for example, may be used as appropriate sources of data to the system 1400.

The components 1405 to 1412 of the computer module 1401 typically communicate via an interconnected bus 1304 and in a manner that results in a conventional mode of operation of the computer system 1400 known to those in the relevant art. For example, the processor 1405 is coupled to the system bus 1404 using a connection 1418. Likewise, the memory 1406 and optical disk drive 1412 are coupled to the system bus 1404 by connections 1419. Examples of computers on which the described arrangements can be practised include IBM-PC's and compatibles, Sun Sparcstations, Apple or like computer systems.

The method 700, where performed by the zone server 140 may be implemented using the computer system 1400. The processes may be implemented as one or more software application programs 1433 executable within the computer system 1400. In particular, the method 700 is effected by instructions in the software 1433 that are carried out within the computer system 1400. The software instructions may be formed as one or more code modules, each for performing one or more particular tasks. The software may also be divided into two separate parts, in which a first part and the corresponding code modules performs the method 700 and a second part and the corresponding code modules manage a user interface between the first part and the user.

The software may be stored in a computer readable medium, including the storage devices described below, for example. The software is loaded into the computer system 1400 from the computer readable medium, and then executed by the computer system 1400. A computer readable medium having such software or computer program recorded on the computer readable medium is a computer program product. The use of the computer program product in the computer system 1400 preferably effects an advantageous apparatus for a zone server 140.

The software 1433 is typically stored in the HDD 1410 or the memory 1406. The software is loaded into the computer system 1400 from a computer readable medium, and executed by the computer system 1400. Thus, for example, the software 1433 may be stored on an optically readable disk storage medium (e.g., CD-ROM) 1425 that is read by the optical disk drive 1412. A computer readable medium having such software or computer program recorded on it is a computer program product. The use of the computer program product in the computer system 1400 preferably effects an apparatus for a zone server 140.

In some instances, the application programs 1433 may be supplied to the user encoded on one or more CD-ROMs 1425 and read via the corresponding drive 1412, or alternatively may be read by the user from the networks 1420 or 1422. Still further, the software can also be loaded into the computer system 1400 from other computer readable media. Computer readable storage media refers to any non-transitory tangible storage medium that provides recorded instructions and/or data to the computer system 1400 for execution and/or processing. Examples of such storage media include floppy disks, magnetic tape, optical disc, a hard disk drive, a ROM or integrated circuit, USB memory, a magneto-optical disk, or a computer readable card such as a PCMCIA card and the like, whether or not such devices are internal or external of the computer module 1401. Examples of transitory or non-tangible computer readable transmission media that may also participate in the provision of software, application programs, instructions and/or data to the computer module 1401 include radio or infra-red transmission channels as well as a network connection to another computer or networked device, and the Internet or Intranets including e-mail transmissions and information recorded on Websites and the like.

The second part of the application programs 1433 and the corresponding code modules mentioned above may be executed to implement one or more graphical user interfaces (GUIs) to be rendered or otherwise represented upon a display. Through manipulation of typically a keyboard and a mouse, a user of the computer system 1400 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

It is to be understood that the structural context of the computer system 1400 (i.e., the zone server 140) is presented merely by way of example. Therefore, in some arrangements, one or more features of the computer system 1400 may be omitted. Also, in some arrangements, one or more features of the computer system 1400 may be combined together. Additionally, in some arrangements, one or more features of the computer system 1400 may be split into one or more component parts.

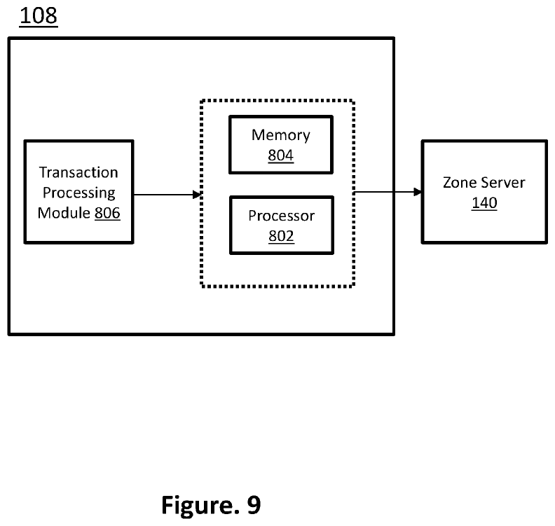

FIG. 9 shows an implementation of the transaction processing server 108 (i.e., the computer system 1300). In this implementation, the transaction processing 108 may be generally described as a physical device comprising at least one processor 802 and at least one memory 804 including computer program codes. The at least one memory 804 and the computer program codes are configured to, with the at least one processor 802, cause the transaction processing server 108 to facilitate the operations described in method 700. The transaction processing server 108 may also include a transaction processing module 806. The memory 804 stores computer program code that the processor 802 compiles to have transaction processing module 806 perform the respective functions.

With reference to FIG. 1, the transaction processing module 806 performs the function of communicating with the requestor device 102 and the provider device 104; and the acquirer server 106 and the issuer server 110 to respectively receive and transmit a transaction, a request for a driver, or other similar messages. The transaction processing module 806 may be configured to process processes relating to a transaction by, for example, forwarding data and information associated with the transaction to the other servers in the system 100 such as the zone server 140. For example, the transaction processing server 108 may, instead of the requestor device 102 or provider device 104, transmit data relating to a request message such as a request for a driver (e.g., date, time, a location, and other similar data) to the zone server 104. The transaction processing server 108 may use a variety of different protocols and procedures in order to process the payment and/or travel co-ordination requests. It will be appreciated that payment for a transaction may be made via a variety of methods such as credit cards, debit cards, digital wallets, buy-first pay-later schemes, and other similar payment methods.

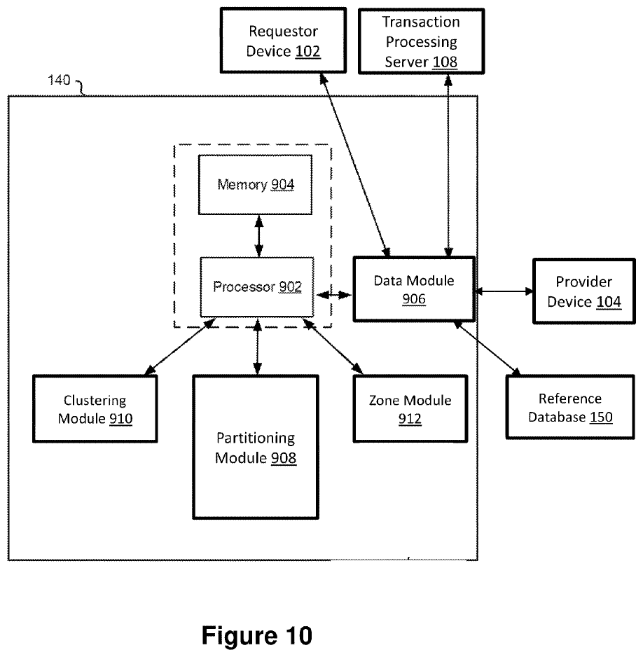

FIG. 10 shows an alternative implementation of the zone server 140 (i.e., the computer system 1400). In the alternative implementation, zone server 140 may be generally described as a physical device comprising at least one processor 902 and at least one memory 904 including computer program codes. The at least one memory 904 and the computer program codes are configured to, with the at least one processor 902, cause the zone server 140 to perform the operations described in the method 700. The zone server 140 may also include a data module 906, a partitioning module 908, a clustering module 910 and a zone module 912. The memory 904 stores computer program code that the processor 902 compiles to have each of the modules 906 to 912 performs their respective functions.

With reference to FIGS. 1 to 7, the partitioning module 908 performs the function of dividing a map into a plurality of areas. For example, the partitioning module 908 may be configured to overlay a plurality of gridlines over the map, each gridline representing a virtual boundary, road or street on the map; and divide the map into the plurality of areas based on the plurality of gridlines.

With reference to FIGS. 1 to 7, the clustering module 910 performs the function of determining, for an area on a map, one or more other areas on the map based on a plurality of trips between the area and each of the one or more areas, each of the area and the one or more other areas corresponding to at least one of a start location and an end location of at least one of the plurality of trips. In an implementation, the clustering module 910 may be further configured to calculate a first distance, the first distance being a summation of a distance between a start location of a first trip of the plurality of trips and a start location of a second trip of the plurality of trips and a distance between an end location of the first trip and an end location of the second trip, the first trip being between the area and a first other area, and the second trip being between the area and a second other area; calculate a second distance, the second distance being a summation of a distance between the start location of the first trip and the end location of the second trip and a distance between the end location of the first trip and the start location of the second trip; determine a shorter distance of the first and second distance; and cluster the area, the first other area and the second other area together based on the determined shorter distance. Determining the area and the one or more other areas may be based on latitudinal and longitudinal coordinates of the start location and stop location of each of the plurality of trips.

With reference to FIGS. 1 to 7, the zone module 912 performs the function of determining, for the area, a corresponding zone based on a corresponding proportion of the plurality of trips between the area and each of the one or more other areas, the zone indicating an association of the area with at least one of the one or more other areas. In an implementation, the zone module may be configured to calculate a total number of the plurality of trips associated with the area, and a corresponding total number of trips between the area and each of the one or more other areas; calculate, for each of the one or more other areas, the corresponding proportion based on the total number of the plurality of trips and the corresponding total number of trips between the area and each of the one or more other areas; and determine a rank for each of the one or more other areas based on the calculated proportion. In an implementation, determining the corresponding zone may be based on a minimum proportion, wherein the corresponding zone indicates only an association between the area and one or more other areas with the calculated proportion that is equal to or exceeds the minimum proportion, determining the corresponding zone based on a maximum rank, the corresponding zone indicating only an association between the area and one or more other areas with the determined rank that is equal to or lower than the maximum rank. In an implementation, determining the corresponding zone may be based on a maximum rank, wherein the corresponding zone indicates only an association between the area and one or more other areas with the determined rank that is equal to or lower than the maximum rank.

With reference to FIGS. 1 to 7, the data module 906 performs the functions of receiving data and information from the requestor device 102, provider device 104, transaction processing server 108, reference database 150, a cloud and other sources of information to determine a zone for an area on a map by the zone server 140. For example, the data module 906 may be configured to receive data and information required for dividing a map into a plurality of areas, determining one or more areas on the map associated with a plurality of trips, perform calculations of distances relating to the plurality of trips, defining a zone for each area of the map, and other similar processes from the requestor device 102, the provider device 104, transaction processing server 108, reference database 150, and/or other sources of information. The data module 906 may be further configured to send information relating to data retrieved in response to the request for a driver to the requestor device 102, the provider device 104, the transaction processing server 108, or other destinations where the information is required.

FIG. 8B depicts a general-purpose computer system 1500, upon which a combined transaction processing server 108 and zone server 140 described can be practiced. The computer system 1500 includes a computer module 1501. An external Modulator-Demodulator (Modem) transceiver device 1516 may be used by the computer module 1501 for communicating to and from a communications network 1520 via a connection 1521. The communications network 1520 may be a wide-area network (WAN), such as the Internet, a cellular telecommunications network, or a private WAN. Where the connection 1521 is a telephone line, the modem 1516 may be a traditional “dial-up” modem. Alternatively, where the connection 1521 is a high capacity (e.g., cable) connection, the modem 1516 may be a broadband modem. A wireless modem may also be used for wireless connection to the communications network 1520.

The computer module 1501 typically includes at least one processor unit 1505, and a memory unit 1506. For example, the memory unit 1506 may have semiconductor random access memory (RAM) and semiconductor read only memory (ROM). The computer module 1501 also includes an interface 1508 for the external modem 1516. In some implementations, the modem 1516 may be incorporated within the computer module 1501, for example within the interface 1508. The computer module 1501 also has a local network interface 1511, which permits coupling of the computer system 1500 via a connection 1523 to a local-area communications network 1522, known as a Local Area Network (LAN). As illustrated in FIG. 8D, the local communications network 1522 may also couple to the wide network 1520 via a connection 1524, which would typically include a so-called “firewall” device or device of similar functionality. The local network interface 1511 may comprise an Ethernet circuit card, a Bluetooth® wireless arrangement or an IEEE 802.11 wireless arrangement; however, numerous other types of interfaces may be practiced for the interface 1511.

The I/O interfaces 1508 may afford either or both of serial and parallel connectivity, the former typically being implemented according to the Universal Serial Bus (USB) standards and having corresponding USB connectors (not illustrated). Storage devices 1509 are provided and typically include a hard disk drive (HDD) 1510. Other storage devices such as a floppy disk drive and a magnetic tape drive (not illustrated) may also be used. An optical disk drive 1512 is typically provided to act as a non-volatile source of data. Portable memory devices, such optical disks, USB-RAM, portable, external hard drives, and floppy disks, for example, may be used as appropriate sources of data to the system 1500.

The components 1505 to 1512 of the computer module 1501 typically communicate via an interconnected bus 1504 and in a manner that results in a conventional mode of operation of the computer system 1500 known to those in the relevant art. For example, the processor 1505 is coupled to the system bus 1504 using a connection 1518. Likewise, the memory 1506 and optical disk drive 1512 are coupled to the system bus 1504 by connections 1519. Examples of computers on which the described arrangements can be practised include IBM-PC's and compatibles, Sun Sparcstations, Apple or like computer systems.

The steps of the method 700 performed by the zone server 140 and facilitated by the transaction processing server 108 may be implemented using the computer system 1500. For example, the steps of the method 700 as performed by the zone server 140 may be implemented as one or more software application programs 1533 executable within the computer system 1500. In particular, the steps of the method 700 are effected by instructions in the software 1533 that are carried out within the computer system 1500. The software instructions may be formed as one or more code modules, each for performing one or more particular tasks. The software may also be divided into two separate parts, in which a first part and the corresponding code modules performs the steps of the method 700 and a second part and the corresponding code modules manage a user interface between the first part and the user.

The software may be stored in a computer readable medium, including the storage devices described below, for example. The software is loaded into the computer system 1500 from the computer readable medium, and then executed by the computer system 1500. A computer readable medium having such software or computer program recorded on the computer readable medium is a computer program product. The use of the computer program product in the computer system 1500 preferably effects an advantageous apparatus for a combined transaction processing and zone server.

The software 1533 is typically stored in the HDD 1510 or the memory 1506. The software is loaded into the computer system 1500 from a computer readable medium, and executed by the computer system 1500. Thus, for example, the software 1533 may be stored on an optically readable disk storage medium (e.g., CD-ROM) 1525 that is read by the optical disk drive 1512. A computer readable medium having such software or computer program recorded on it is a computer program product. The use of the computer program product in the computer system 1500 preferably effects an apparatus for a combined transaction processing and zone server.

In some instances, the application programs 1533 may be supplied to the user encoded on one or more CD-ROMs 1525 and read via the corresponding drive 1512, or alternatively may be read by the user from the networks 1520 or 1522. Still further, the software can also be loaded into the computer system 1500 from other computer readable media. Computer readable storage media refers to any non-transitory tangible storage medium that provides recorded instructions and/or data to the computer system 1500 for execution and/or processing. Examples of such storage media include floppy disks, magnetic tape, optical disc, a hard disk drive, a ROM or integrated circuit, USB memory, a magneto-optical disk, or a computer readable card such as a PCMCIA card and the like, whether or not such devices are internal or external of the computer module 1501. Examples of transitory or non-tangible computer readable transmission media that may also participate in the provision of software, application programs, instructions and/or data to the computer module 1501 include radio or infra-red transmission channels as well as a network connection to another computer or networked device, and the Internet or Intranets including e-mail transmissions and information recorded on Websites and the like.

The second part of the application programs 1533 and the corresponding code modules mentioned above may be executed to implement one or more graphical user interfaces (GUIs) to be rendered or otherwise represented upon a display. Through manipulation of typically a keyboard and a mouse, a user of the computer system 1500 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

It is to be understood that the structural context of the computer system 1500 (e.g., combined transaction processing and zone server 1500) is presented merely by way of example. Therefore, in some arrangements, one or more features of the server 1500 may be omitted. Also, in some arrangements, one or more features of the server 1500 may be combined together. Additionally, in some arrangements, one or more features of the server 1500 may be split into one or more component parts.

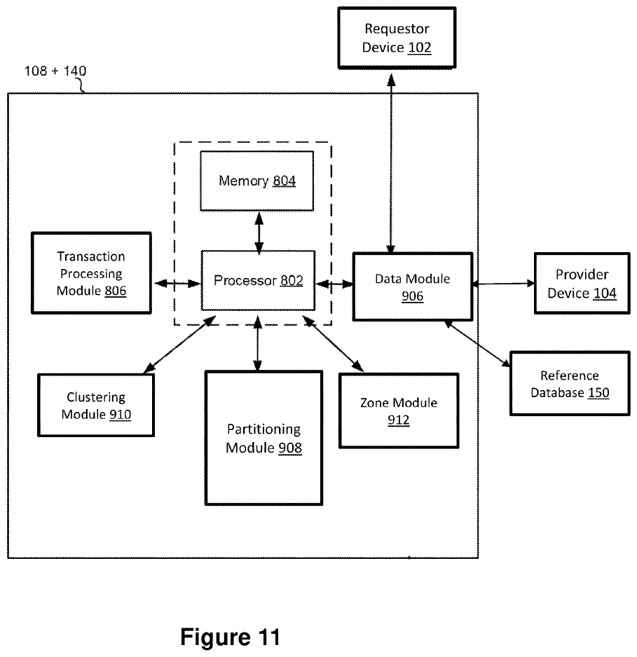

FIG. 11 shows an alternative implementation of combined transaction processing and zone server (i.e., the computer system 1500). In the alternative implementation, the combined transaction processing and zone server may be generally described as a physical device comprising at least one processor 1002 and at least one memory 904 including computer program codes. The at least one memory 1004 and the computer program codes are configured to, with the at least one processor 1002, cause the combined transaction processing and zone server to perform the operations described in the steps of the method 700. The combined transaction processing and zone server may also include a transaction processing module 806, a data module 906, a partitioning module 908, a clustering module 910 and a zone module 912. The memory 1004 stores computer program code that the processor 1002 compiles to have each of the modules 806 to 912 performs their respective functions. The transaction processing module 806 performs the same functions as described for the same transaction processing module in FIG. 9. The data module 906, partitioning module 908, clustering module 910 and zone module 912 perform the same functions as described for the same corresponding modules in FIG. 10.

It will be appreciated by a person skilled in the art that numerous variations and/or modifications may be made to the present disclosure as shown in the specific embodiments without departing from the scope of the specification as broadly described. The present embodiments are, therefore, to be considered in all respects to be illustrative and not restrictive.

1. A method for determining a zone for an area on a map, comprising:
determining, by a processor, for an area on a map, one or more other areas on the map based on a plurality of trips between the area and each of the one or more areas, each of the area and the one or more other areas corresponding to at least one of a start location and an end location of at least one of the plurality of trips; and
determining, by the processor, for the area, a corresponding zone based on a corresponding proportion of the plurality of trips between the area and each of the one or more other areas, the zone indicating an association of the area with at least one of the one or more other areas.

2. The method of claim 1, wherein determining the corresponding zone further comprises:
calculating a total number of the plurality of trips associated with the area, and a corresponding total number of trips between the area and each of the one or more other areas;
calculating, for each of the one or more other areas, the corresponding proportion based on the total number of the plurality of trips and the corresponding total number of trips between the area and each of the one or more other areas; and
determining a rank for each of the one or more other areas based on the calculated proportion.

3. The method of claim 2, further comprising determining the corresponding zone based on a minimum proportion, the corresponding zone indicating only an association between the area and one or more other areas with the calculated proportion that is equal to or exceeds the minimum proportion.

4. The method of claim 2, further comprising determining the corresponding zone based on a maximum rank, the corresponding zone indicating only an association between the area and one or more other areas with the determined rank that is equal to or lower than the maximum rank.

5. The method of claim 1, wherein determining the one or more other areas further comprises:
calculating a first distance, the first distance being a summation of a distance between a start location of a first trip of the plurality of trips and a start location of a second trip of the plurality of trips and a distance between an end location of the first trip and an end location of the second trip, the first trip being between the area and a first other area, and the second trip being between the area and a second other area;
calculating a second distance, the second distance being a summation of a distance between the start location of the first trip and the end location of the second trip and a distance between the end location of the first trip and the start location of the second trip;
determining a shorter distance of the first and second distance; and
clustering the area, the first other area and the second other area together based on the determined shorter distance.

6. The method of claim 1, further comprising:
overlaying a plurality of gridlines over the map, each gridline representing a virtual boundary, road or street on the map; and
dividing the map into a plurality of areas based on the plurality of gridlines, the plurality of areas including the area and the one or more other areas.

7. The method of claim 1, further comprising determining the area and the one or more other areas based on latitudinal and longitudinal coordinates of the start location and stop location of each of the plurality of trips.

8. A system for determining a zone for an area on a map, comprising:
at least one processor; and at least one memory including computer program code; the at least one memory and the computer program code configured to, with the at least one processor, cause the system at least to:
determine, for an area on a map, one or more other areas on the map based on a plurality of trips between the area and each of the one or more areas, each of the area and the one or more other areas corresponding to at least one of a start location and an end location of at least one of the plurality of trips; and
determine, for the area, a corresponding zone based on a corresponding proportion of the plurality of trips between the area and each of the one or more other areas, the zone indicating an association of the area with at least one of the one or more other areas.

9. The system of claim 8, wherein determining the corresponding zone further comprises:
calculating a total number of the plurality of trips associated with the area, and a corresponding total number of trips between the area and each of the one or more other areas;
calculating, for each of the one or more other areas, the corresponding proportion based on the total number of the plurality of trips and the corresponding total number of trips between the area and each of the one or more other areas; and
determining a rank for each of the one or more other areas based on the calculated proportion.

10. The system of claim 9, further configured to determine the corresponding zone based on a minimum proportion, the corresponding zone indicating only an association between the area and one or more other areas with the calculated proportion that is equal to or exceeds the minimum proportion.

11. The system of claim 9, further configured to determine the corresponding zone based on a maximum rank, the corresponding zone indicating only an association between the area and one or more other areas with the determined rank that is equal to or lower than the maximum rank.

12. The system of claim 8, wherein determining the one or more other areas further comprises:
calculating a first distance, the first distance being a summation of a distance between a start location of a first trip of the plurality of trips and a start location of a second trip of the plurality of trips and a distance between an end location of the first trip and an end location of the second trip, the first trip being between the area and a first other area, and the second trip being between the area and a second other area;
calculating a second distance, the second distance being a summation of a distance between the start location of the first trip and the end location of the second trip and a distance between the end location of the first trip and the start location of the second trip;
determining a shorter distance of the first and second distance; and
clustering the area, the first other area and the second other area together based on the determined shorter distance.

13. The system of claim 8, further configured to:
overlay a plurality of gridlines over the map, each gridline representing a virtual boundary, road or street on the map; and
divide the map into a plurality of areas based on the plurality of gridlines, the plurality of areas including the area and the one or more other areas.

14. The system of claim 8, further configured to determine the area and the one or more other areas based on latitudinal and longitudinal coordinates of the start location and stop location of each of the plurality of trips.
